(19) United States
(12) Patent Application Publication
(10) Pub. No.: US 2011/0004898 A1
(43) Pub. Date: Jan. 6, 2011

(54) Attracting Viewer Attention to Advertisements Embedded in Media

(76) Inventors: Huntley Stafford Ritter, Kalispell, MT (US); Matthew Ambert Hartle, Kalispell, MT (US)

Correspondence Address: MERCHANT & GOULD PC, P.O. BOX 2903, MINNEAPOLIS, MN, 55402-0903, US

(21) Appl. No.: 12/829,113

(22) Filed: Jul. 1, 2010

Related U.S. Application Data
(60) Provisional application No. 61/222,579, filed on Jul. 2, 2009.

(51) Int. Cl. H04N 7/025; H04N 5/91

(52) U.S. Cl. 725/32; 386/E05.003

(57) ABSTRACT

An entity distributes media containing at least one embedded advertisement and a target artifact designed to draw a viewer's attention to the advertisement. The viewer is encouraged to look for the target artifact in the media, but is not told where the target artifact is in the media. Because the viewer is looking for the target artifact, the viewer is more likely to view the advertisements embedded in the media when a playback device plays back the media. When the viewer notices the target artifact, the viewer selects the target artifact. In response, the playback device accesses a target resource.

### RELATED APPLICATION

This application claims the benefit of U.S. Patent Application Ser. No. 61/222,579 filed on Jul. 2, 2009, the entirety of which is hereby incorporated by reference.

### BACKGROUND

Product placement is a technique where branded goods or services are advertised in a context usually devoid of advertisements. For example, branded goods or services may be advertised in movies and television shows. A goal of such product placement is to make the viewers feel like the advertised products or services are used by characters or at least are pervasive parts of the environment inhabited by the characters.

Frequently, advertisements are placed in unobtrusive parts of movies and television shows so as not to distract viewers from the primary action of the movies or television shows. For instance, a billboard advertising a brand of soft drinks may appear in the background of an outdoor scene of a movie. However, because the advertisements are placed in unobtrusive parts of movies and television shows, viewers frequently overlook the advertisements.

### SUMMARY

An entity distributes media containing at least one embedded advertisement and a target artifact designed to draw a viewer's attention to the advertisement. The viewer is encouraged to look for the target artifact in the media, but is not told where the target artifact is in the media. Because the viewer is looking for the target artifact, the viewer is more likely to view the advertisements embedded in the media when a playback device plays back the media. When the viewer notices the target artifact, the viewer selects the target artifact. In response, the playback device accesses a target resource.

This summary is provided to introduce a selection of concepts in a simplified form. These concepts are further described below in the Detailed Description. This summary is not intended to identify key features or essential features of the claimed subject matter, nor is this summary intended as an aid in determining the scope of the claimed subject matter.

### DESCRIPTION OF THE DRAWINGS

FIG. 1 illustrates an example media distribution system.

FIG. 2 illustrates example functional components of a server computing system.

FIG. 3 illustrates example functional components of a playback device.

FIG. 4 illustrates an example video including an embedded advertisement.

FIG. 5 illustrates another portion of the video of FIG. 4 including a target artifact.

FIG. 6 illustrates an example operation of an entity to distribute a video containing a target artifact designed to attract a viewer's attention to advertisements embedded in the video.

FIG. 7 illustrates an example operation of the playback device to play back the video.

FIG. 8 illustrates an example operation of the server computing system to distribute the video.

FIG. 9 illustrates an example operation of a video modification module to modify the video to contain the target artifact and the advertisements.

FIG. 10 illustrates example physical components of an electronic computing device.

### DETAILED DESCRIPTION

As briefly described above, an entity distributes media containing at least one embedded advertisement and a target artifact designed to draw a viewer's attention to the advertisement. The techniques of this disclosure are described with reference to the attached figures. It should be appreciated that the attached figures are provided for purposes of explanation only and should not be understood as representing a sole way of implementing the techniques of this disclosure.

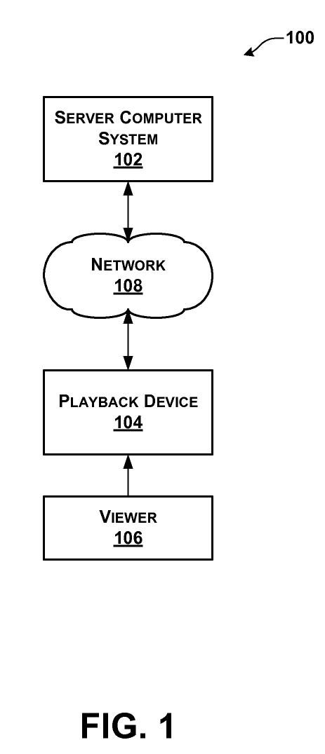

FIG. 1 illustrates an example media distribution system 100 that distributes a media. It should be appreciated that the media distribution system 100 is merely an example and that there may be many other possible media distribution systems that distribute the media.

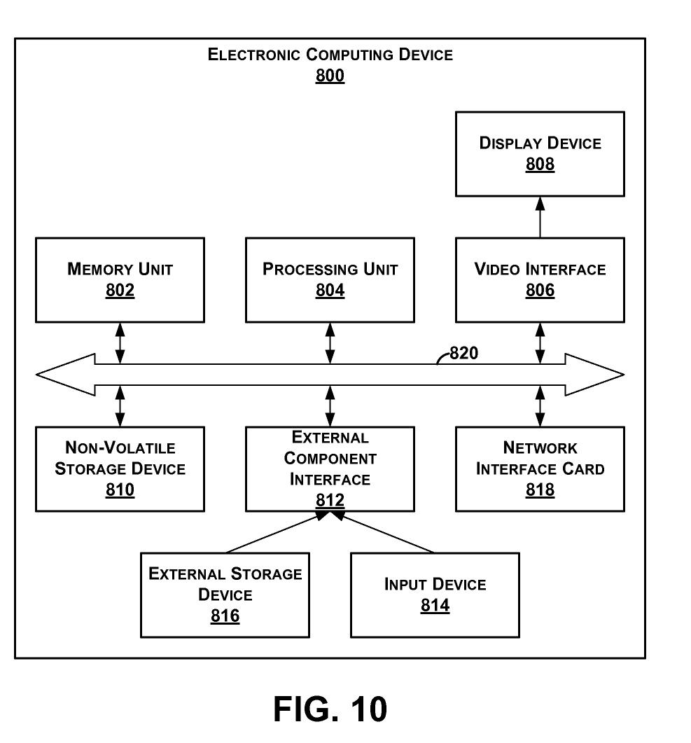

As illustrated in the example of FIG. 1, the media distribution system 100 comprises a server computing system 102. The server computing system 102 is an electronic computing system. As used in this disclosure, an electronic computing system is a set of one or more physical electronic computing devices. For instance, the server computing system 102 may comprise twenty separate physical electronic computing devices. An electronic computing device is a physical machine that comprises physical electronic components. Electronic components are physical entities that affect electrons or fields of electrons in a desired manner consistent with the intended function of an electronic computing device. Example types of electronic components include capacitors, resistors, diodes, transistors, and other types of physical entities that affect electrons or fields of electrons in a manner consistent with the intended function of an electronic computing device. An example physical computing device is described below with reference to FIG. 10.

The server computing system 102 is operated by or on behalf of an entity. As used in this disclosure, an entity is a natural or legal entity. Example types of entities include corporations, partnerships, proprietorships, companies, non-profit corporations, foundations, estates, governmental agencies, and other types of legal entities. In different instances, the server computing system 102 is operated by or on behalf of different types of entities.

In some implementations, the server computing system 102 is operated by a web services provider on behalf of the entity. In such implementations, the entity may not be aware of how the server computing system 102 is implemented. Consequently, services provided by the server computing system 102 may appear, from the perspective of the entity, to be provided by “the cloud.” In the terminology of cloud computing, “the cloud” refers to a network of physical electronic computing devices in which the individual physical electronic computing devices are abstracted away.

The media distribution system 100 also comprises a playback device 104. The playback device 104 is an electronic computing system that is able to play back media, such as a video. In different instances, the playback device 104 may be a wide variety of different types of electronic computing systems. For example, the playback device 104 may be a personal computer, a lap top computer, a cellular telephone, a smartphone, a watch, a video game console, a netbook, a personal media player, a device integrated into a vehicle, a television set top box, a network appliance, a server device, a supercomputer, a mainframe computer, or another type of electronic computing system.

As used in this disclosure, playing back media requires rendering of the media in a format that can be consumed by a viewer. In most examples provided herein, the media is video, although other types of media, such as games, can also be used.

For example, if the media is video, the playback of the video entails rendering video data to produce the video. Furthermore, as used in this disclosure, a video is a displayed sequence of frames in which frames are replaced in succession to create an illusion of motion. As used in this disclosure, a frame is a still visible image. A viewer is a person viewing a video. Moreover, video data is data that, when appropriately rendered, produces a video.

A viewer 106 views videos played back by the playback device 104. The viewer 106 is an individual human being. It should be appreciated that in some instances, multiple viewers at the same time are able to view a video played back by the playback device 104.

The media distribution system 100 also comprises a network 108. The network 108 is an electronic communication network that facilitates communication between the server computing system 102 and the playback device 104. As used in this disclosure, an electronic communication network is a network of two or more electronic computing devices (e.g., server computing system 102 and the playback device 104) having one or more communication links, the electronic computing devices configured to use the communication links communicate electronic data.

The network 108 may be a wide variety of different types of electronic communication network. For example, the network 108 may be a wide-area network, such as the Internet, a local-area network, a metropolitan-area network, or another type of electronic communication network. The network 108 may include wired and/or wireless data links. A variety of communications protocols may be used in the network 108 including, but not limited to, Ethernet, Transport Control Protocol (TCP), Internet Protocol (IP), Hypertext Transfer Protocol (HTTP), SOAP, remote procedure call protocols, and/or other types of communications protocols. In some implementations, the server computing system 102 and the playback device 104 communicate via the network 108 securely. In a first example, the server computing system 102 and the playback device 104 use secure sockets layer (SSL) techniques to communicate securely over the network 108. In another example, the server computing system 102 and the playback device 104 use IPSec to communicate securely over the network 108.

In the example of FIG. 1, the playback device 104 receives video data from the server computing system 102 via the network 108. In different instances, the playback device 104 receives the video data from the server computing system 102 in different ways. In a first instance, the playback device 104 receives a video file containing the video data from the server computing system 102 via the network 108. As used in this disclosure, a video file is a file containing video data. Furthermore, as used in this disclosure, a file is a set of data that has a name and that persists when no computer process is using it. In a second instance, the playback device 104 receives a video stream from the server computing system 102 via the network 108. The video stream contains the video data. As used in this disclosure, a video stream is a succession of video data supplied over time.

It should be appreciated that in other media distribution systems, playback devices do not necessarily receive video data from server computing systems via electronic communications networks. For example, in one example media distribution system, video data is stored on a computer-readable data storage medium. A computer-readable data storage medium is a device or article of manufacture that stores data that can be read by an electronic computing device. Example types of computer-readable data storage media include CD-ROMS, compact discs, digital versatile discs (DVDs), Blu-ray discs, solid-state memory devices, magnetic disks, read-only memory units, random access memory modules, and other types of devices or articles of manufacture that store data that can be read by an electronic computing device. In this example, a playback device receives the video data when a user inserts a computer-readable data storage medium storing the video data into a reader device configured to read data from the computer-readable data storage medium. The reader device is integrated into or connected to the playback device such that the playback device receives data read by the reader device.

Furthermore, it should be appreciated that in some implementations, the playback device 104 receives the video data by dynamically generating the video data. In such implementations, the playback device 104 may dynamically generate the video data by executing software instructions. For example, the playback device 104 may store a video game application that, when executed by the playback device 104, presents a video game. In this example, the video game application may dynamically generate the video data.

When the playback device 104 receives the video data, the playback device 104 plays back the video. The video comprises a sequence of frames. The sequence of frames comprises a first set of frames and a second set of frames. In some instances, the sequence of frames includes frames in addition to those in the first set of frames and the second set of frames. Furthermore, in some instances, the first set of frames and the second set of frames include the same frame.

Each frame in the first set of frames comprises a different region in a first set of visually corresponding regions. As used in this disclosure, a region of a frame is a bounded sub-section of the frame. A region of a frame does not include the entire frame. Visually corresponding regions are bounded sub-sections of frames in a series of frames each containing digital images of the same object. For example, a series of frames in the video may include digital images of a billboard in the background of a scene. In this example, the regions of the frames containing the digital images of the billboard are visually corresponding regions. It should be appreciated that, in some instances, regions in a set of visually corresponding regions differ from frame to frame. For example, the image of the billboard may move around, become bigger or smaller, may change color, may be partially obscured by another object, and so on during the course of the series of frames. In this example, the regions differ from frame to frame such that the region of each frame includes the image of the billboard.

The region in the first set of visually corresponding regions contains an advertisement. As used in this disclosure, an advertisement is an artifact designed to raise a viewer's awareness of a product offered by an entity. As used in this disclosure, a product is a good or service. Furthermore, as used in this disclosure, an artifact is a digital image or animated sequence of digital images. For example, a company's logo is an artifact designed to raise a viewer's awareness of a product offered by the company.

In an original version of the video, the first set of visually corresponding regions does not contain the advertisement or contains an undesired advertisement. However, after the original version of the video was produced, the first set of visually corresponding regions is modified such that the first set of visually corresponding regions contains the desired advertisement.

For example, assume that the video is a movie produced in the year 1996. In the background of a scene of the movie, there is a blank exterior wall of a building. In this example, the first set of visually corresponding regions contains the digital image of the wall. Furthermore, in this example, in the year 2009 the movie is set to be re-released on the Internet. In advance of the re-release of the movie, the image within the first set of corresponding regions is modified such that instead of containing images of the blank wall, the first set of visually corresponding regions contains images of the wall, except with a company's logo painted on the wall. As discussed below, an entity responsible for re-releasing the movie may receive compensation from advertising agencies and companies to embed advertisements in this way. In some instances, the video may contain a plurality of such sets of visually corresponding regions containing advertisements.

In many instances, the advertisement is located in an unobtrusive location within the video. That is, the advertisement is located away from where viewers' attention is likely to be. As opposed to locating advertisements at locations where the viewers' attention is likely to be, locating advertisements at unobtrusive locations may make the video feel more natural and may improve the viewing experience of the viewer 106. For example, the advertisement may be in the background. In a second example, the advertisement may be in the foreground, but not a part of the foreground where the primary action is occurring. In a third example, the advertisement may be in a part of a scene that is not completely in focus.

Each frame in the second set of frames comprises a different region in a second set of visually corresponding regions. Each region in the second set of visually corresponding regions contains a target artifact. The target artifact is an artifact for which the viewer 106 is encouraged to look. The target artifact may be a wide variety of different types of artifact.

For example, the target artifact may be a digital image of a particular type of handbag. In another example, the target artifact may be a digital image of a particular type of telephone. In different instances, the target artifact may or may not be an advertisement. Furthermore, in different instances, the target artifact may or may not be in an original version of the video. For instance, in the movie example of the previous paragraph, the version of the movie produced in 1996 may or may not include the target artifact.

The viewer 106 is provided with a message that encourages the viewer 106 to look for the target artifact. In different instances, the message is provided to the viewer 106 in different ways. In a first example, the video may contain frames that include a printed message encouraging the viewer 106 to look for the target artifact in the video. In this first example, the printed message may read “when you find a green coffee cup in this video, click on it to be entered in a drawing for a free prize!” In a second example, the video may be accompanied by audio in which the viewer 106 is verbally encouraged to look for the target artifact in the video. In a third example, a web page may include a printed message that encourages the viewer 106 to look for the target artifact in the video. In this third example, the web page may be a page in which the video is embedded or another web page. Furthermore, in this third example, the message may be embedded into the web page as an advertisement or as part of the normal content of the web page. In a fourth example, a physical medium (e.g., newspaper, magazine, billboard, brochures, handouts, product packaging for the video or another good, etc.) may contain a message encouraging the viewer 106 to look for the target artifact in the video. In a fifth example, a message encouraging the viewer 106 to look for the target artifact in the video is transmitted to the viewer 106 via a broadcast medium (e.g., aerial television, satellite television, cable television, Internet television, aerial radio, satellite radio, Internet radio, etc.) or via another information distribution medium (e.g., instant messages, text messages, TWITTER, e-mail messages, social networking sites, etc.). In a sixth example, a person encourages the viewer 106 to look for the target artifact in the video. In this sixth example, the person may be an actor in the video, a celebrity, or some other person.

Furthermore, in some instances, the message encourages the viewer 106 to look for the target artifact with the promise of a reward to the viewer 106 if the viewer 106 finds the target artifact. In a first example, the message encourages the viewer 106 to look for the target artifact with the promise that the viewer 106 will have a chance to win a prize if the viewer 106 finds the target artifact. In this first example, the prize may be associated with the content of the video. For instance, if the video is an episode of a television show about fashionable New York women, the prize may be a pair of shoes from a luxury shoe designer. In a second example, the message encourages the viewer 106 to look for the target artifact with the promise that the viewer 106 will be shown special footage if the viewer 106 finds the target artifact. In this second example, the special footage may be a deleted scene of a movie, a trailer for a highly anticipated upcoming movie, scenes from an upcoming episode of a television program, and so on. In a third example, the message encourages the viewer 106 to look for the target artifact with the promise that the viewer 106 will be able to access a secret level of a video game, unlock a special video game character, play a secret game, etc.

In some embodiments, there can be a varying number of prizes. For example, if the video is a full-length movie, there can be 6-10 prizes with associated target artifacts embedded in the movie. The menu or opening credits for the movie can explain the contest and identify the different target artifacts (e.g., icons) for which to look in the movie and the associated prizes for each. Some of the prizes may be small (e.g., a pair of sunglasses), while others can be large (e.g., cash prizes, cars, motorcycles, etc.). For the smaller prizes the viewer can select the artifact within the movie and provide contact information, such as name, age, and email address, so that the prize can be sent directly to the viewer. For larger prizes, the viewer may provide contact information so that the viewer can be entered into a contest (e.g., lottery, raffle) to win the larger prize. Other variations are possible.

In yet another embodiment, the viewer is given a code, such as a number, when the viewer spots the target artifact. The viewer can then use the number at a later point to play a game and/or win a prize. For example, the viewer can send a text to the number provided to receive information about accessing a game. The viewer can then play the game to win prizes.

During playback of the video, the target artifact is at least somewhat difficult for the viewer 106 to perceive except when the viewer 106 is paying attention to details of the video. For example, the target artifact may be small in size. In a second example, the target artifact may only be shown in the video for a short amount of time. In a third example, the target artifact may be in a part of a scene that is not where the viewer 106 would typically focus his or her attention. For instance, in this third example, if two characters in a movie are fighting in the foreground while traveling down a highway at great speed, the attention of the viewer 106 would likely be focused on the fighting action in the foreground. Consequently, in this third example, when the viewer 106 is not paying attention to details in the video it would be at least somewhat difficult for the viewer 106 to perceive the target artifact when the target artifact is on a truck in the background moving in the opposite direction.

In typical instances, the viewer 106 is not told where or when the target artifact appears in the video. Because the target artifact is at least somewhat difficult for viewer 106 to perceive except when the viewer 106 is paying attention to details of the video, the viewer 106 is more likely to be pay close attention to details throughout the video. Because the viewer 106 is more likely to pay close attention to details throughout the video, the viewer 106 is more likely to notice the one or more advertisements unobtrusively inserted into the video. Having the viewer 106 notice an advertisement is a chief goal of an advertiser.

When the viewer 106 finds the target artifact in the video while the playback device 104 is playing back the video, the viewer 106 is able to select the target artifact. As used in this disclosure, selecting the target artifact entails providing, by the viewer 106, selection input to the playback device 104. The selection input indicates that the viewer 106 has selected a location within or reasonably close to a region in the second set of visually corresponding regions of the second set of frames. Because the target artifact may be quite small, selecting the target artifact itself may be relatively difficult while the video is being played back. Accordingly, in some implementations, if the selection input indicates that the viewer 106 has selected a location relatively close to the target artifact (e.g., in the same quadrant of the second set of frames as the target artifact) the selection input is taken to indicate that the viewer 106 has selected the target artifact.

In different instances, the playback device 104 receives the selection input in different ways. For example, the playback device 104 may receive the selection input via an input device. Example types of input devices include mice, trackballs, stylus input devices, keywords, video game control pads, joysticks, movement-sensitive controllers (e.g., Nintendo WII® remote controllers, etc.), gun type video game controllers, musical instrument type video game controllers, touch sensitive screens, television/home entertainment system remote controllers, and other types of input devices.

In response to receiving the selection input, the playback device 104 accesses a target resource. The playback device 104 does not access the target resource when the playback device 104 does not receive a selection input that indicates that the viewer 106 has selected the target artifact.

The target resource may be a wide variety of different types of resources. The target resource may be a game, software instructions that unlock a special video game character, video footage, software instructions that unlock a video game level, a web page that allows the viewer 106 to enter information to be entered in a drawing for a prize, and so on.

In different instances, the playback device 104 accesses the target resource in different ways. For instance, the playback device 104 may access the target resource in different ways depending on the type of the target resource. In a first example, the target resource is a web page. In this first example, the playback device 104 accesses the web page by transmitting a resource request to a server computing system that hosts the web page, receiving the web page in response to the resource request, and displaying the web page. Furthermore, in this first example, the server computing system that hosts the web page may or may not be the server computing system 102. In a second example, the target resource is a game. In this second example, the playback device 104 accesses the resource by executing software instructions that cause the playback device 104 to present the game.

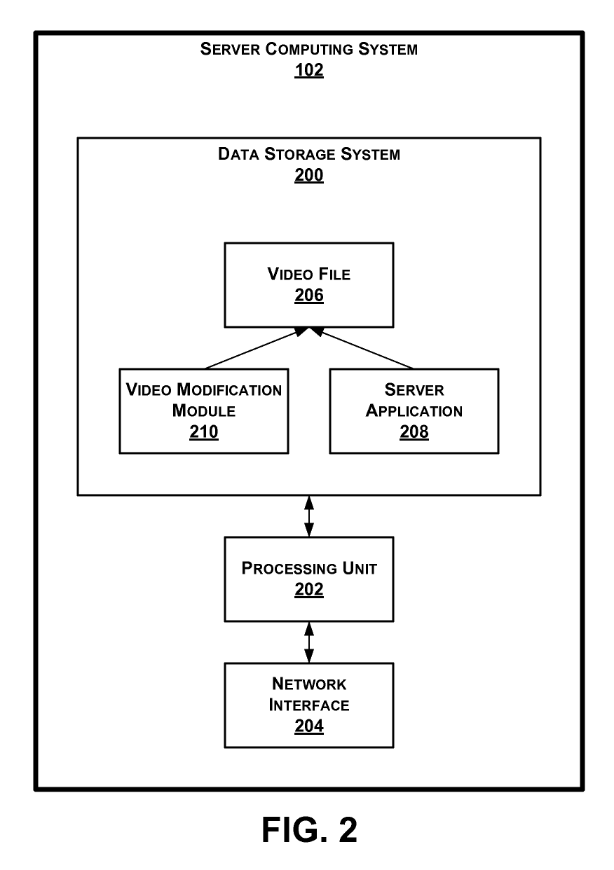

FIG. 2 illustrates example functional components of the server computing system 102. It should be appreciated that FIG. 2 is an example provided for purposes of explanation only. In other instances, the server computing system 102 may contain different logical components. As used in this disclosure, a functional component is a sub-part of a system, the sub-part having a well-defined purpose and functionality.

As illustrated in the example of FIG. 2, the server computing system 102 comprises a data storage system 200, a processing unit 202, and a network interface 204. The network interface 204 enables the server computing system 102 to transmit data on the network 108 and to receive data from the network 108. As used in this disclosure, a network interface is a set of one or more physical network interface cards. Furthermore, as used in this disclosure, a network interface card is a computer hardware component designed to allow a computer to communicate over an electronic communication network. In some example implementations, the network interface 204 is able to store data received from the network 108 directly into the data storage system 200 and to directly transmit on the network 108 data stored in the data storage system 200.

As illustrated in the example of FIG. 2, the data storage system 200 stores a video file 206, a server application 208, and a video modification module 210. As mentioned above, the server computing system 102 is a collection of one or more electronic computing devices and the data storage system 200 is a collection of one or more computer-readable data storage media. In implementations where the server computing system 102 comprises a plurality of electronic computing devices and the data storage system 200 comprises a plurality of computer-readable data storage media, one or more of the video file 206, the server application 208, and the video modification module 210 may be stored at different computer-readable data storage media and potentially at computer-readable data storage media in different electronic computing devices. For instance, the server application 208 may be stored at a computer-readable data storage medium at a first server device at a server farm and the video modification module 210 may be stored at a plurality of computer-readable data storage media at a second server device in the server farm.

In some example implementations, the server application 208 comprises a set of software instructions. This disclosure includes statements that describe the server application 208 as performing various actions. Such statements should be interpreted to mean that the server computing system 102 performs the various actions when the processing unit 202 executes software instructions of the server application 208.

As used in this disclosure, a software application is a set of software instructions that, when executed by a processing unit of a computing system, cause the computing system to provide a computerized tool with which a user can interact. As used in this disclosure, a processing unit is a set of one or more physical integrated circuits capable of executing software instructions. As used in this disclosure, a software instruction is a data structure that represents an operation of a processing unit. For example, a software instruction may be a data structure comprising an operation code and zero or more operand specifiers. In this example, the operand specifiers may specify registers, memory addresses, or literal data.

The server application 208 receives resource requests from the network 108 via the network interface 204 and responds appropriately to the resource requests. As used in this disclosure, a resource request is a request to perform an action on a resource. Example types of resource requests include get requests that request the server application 208 to return copies of resources to computing systems, delete requests that request the server application 208 to delete resources, post requests that request the server application 208 to submit data to specified resources, and other types of requests to perform actions on resources. In addition, the server application 208 comprises software instructions that, when executed by the processing unit 202, cause the server computing system 102 to respond appropriately to the resource requests. When the server application 208 receives from a computing system a get resource request that specifies the web form 116, the server application 208 transmits a copy of a request resource to the computing system.

In the example of FIG. 2, the server application 208 receives a resource request from the playback device 104. The resource request requests a video. In response to the resource request, the server application 208 transmits video data to the playback device 104. The video data can be rendered as the video. In one example implementation, the server application 208 transmits a copy of the video file 206 to the playback device 104. In another example implementation, the server application 208 transmits a video stream to the playback device 104. The video stream contains video data in the video file 206.

In some example implementations, the video modification module 210 comprises a set of software instructions. This disclosure includes statements that describe the video modification module 210 as performing various actions. Such statements should be interpreted to mean that the server computing system 102 performs the various actions when the processing unit 202 executes software instructions of the video modification module 210. As described below, the video modification module 210 modifies the video file 206 such that the video includes one or more advertisements and a target resource.

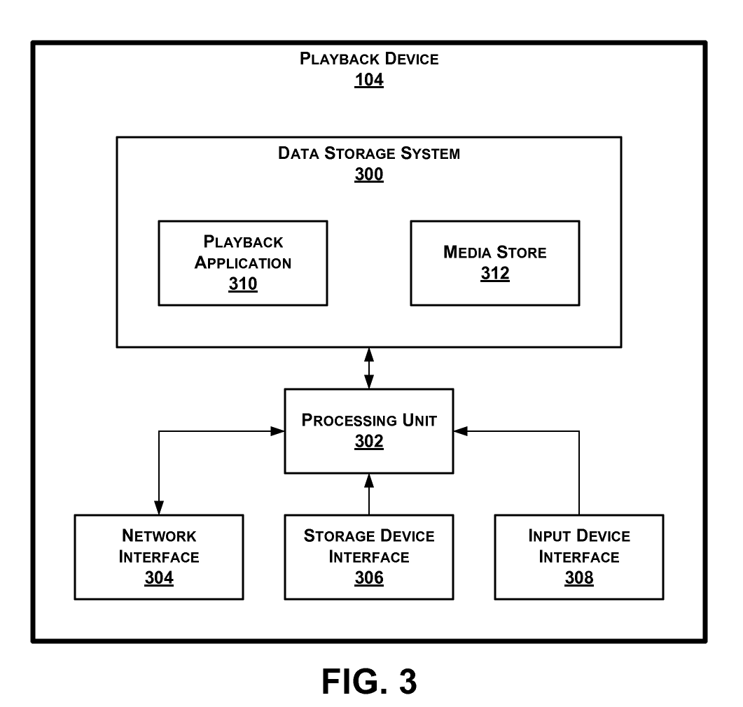

FIG. 3 illustrates example functional components of the playback device 104. It should be appreciated that FIG. 3 is an example provided for purposes of explanation only. In other instances, the playback device 104 may contain different logical components.

As illustrated in the example of FIG. 3, the playback device 104 comprises a data storage system 300, a processing unit 302, a network interface 304, a storage device interface 306, and an input device interface 308. The data storage system 300 stores a playback application 310 and a media store 312. The network interface 304 enables the playback device 104 to transmit data on the network 108 and to receive data from the network 108. The storage device interface 306 enables the playback device 104 to read data from one or more computer-readable data storage media external to the playback device (i.e., an external data storage medium). The input device interface 308 enables the playback device 104 to receive input from an input device controlled by the viewer 106.

In some example implementations, the playback application 310 comprises a set of software instructions. This disclosure includes statements describing the playback application 310 as performing various actions. Such statements should be interpreted to mean that the playback device 104 performs the various actions when the processing unit 302 executes software instructions of the playback application 310. As described below, the playback application 310 plays back videos.

It should be appreciated that in alternate implementations, functional components of the playback device 104 are implemented as separate physical electronic computing devices. For example, a first physical electronic computing device at a location of the viewer 106 may receive input from an input device control by the viewer 106 and transmit the input to a second physical electronic computing device via an electronic communications network. In this example, the second physical electronic computing device may process the input and the video data and transmit the processed video data to a third physical electronic computing device at the location of the viewer 106. The third physical electronic computing device uses the processed video data to display the video. In this way, input processing and video processing appears, from the perspective of the viewer 106, to be performed by the cloud.

The media store 312 stores video data on a temporary or persistent basis. In a first example, the media store 312 stores one or more video files. In a second example, the media store 312 stores video data received in a video stream. In a third example, the media store 312 stores software instructions of a video game application that generates video.

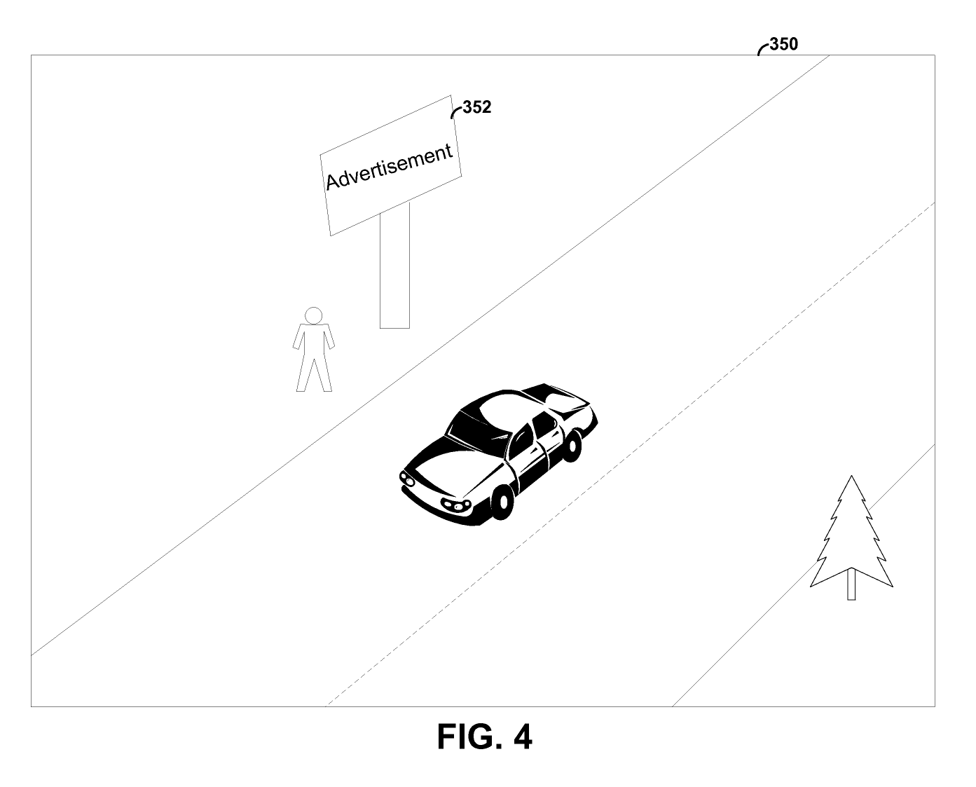

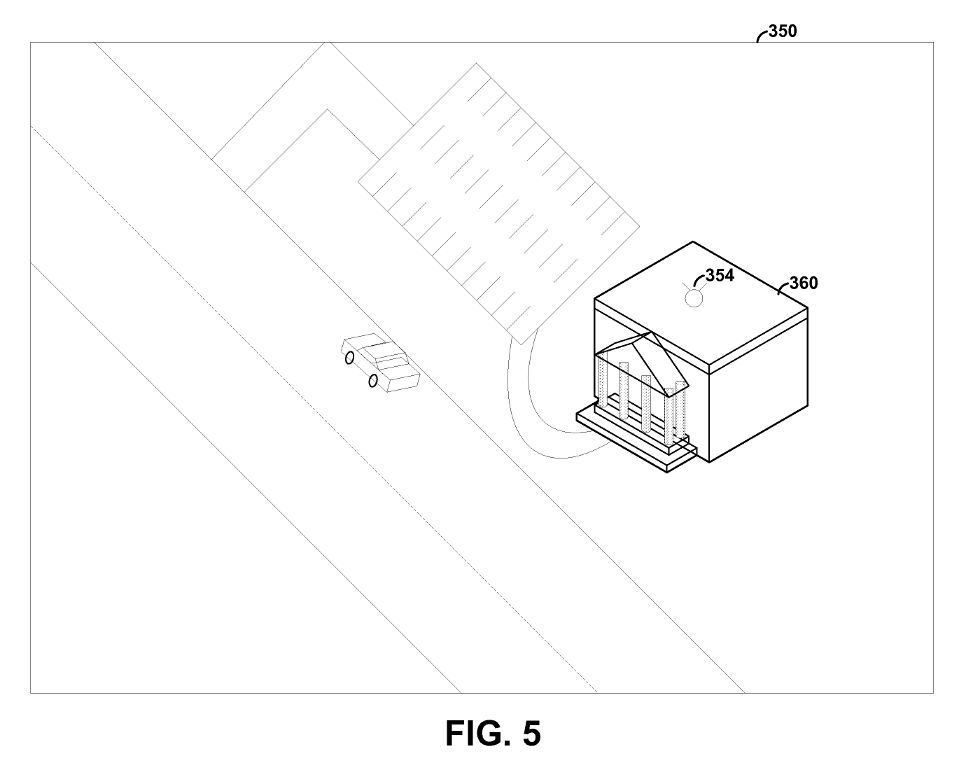

FIGS. 4 and 5 illustrate one example of a video 350 into which an embedded advertisement and target artifact have been introduced. In FIG. 4, the video 350 is shown in a sequence including a billboard 352. The content of the billboard is replaced or overlaid with an embedded advertisement that is added at a point after which the video 350 was created. When the viewer 106 views the video 350, the viewer sees the billboard with the embedded advertisement.

In FIG. 5, another sequence of the video 350 is shown. In this sequence, the target artifact 354 has been embedded on top of a building 360. As the viewer 106 watches the video 350, the viewer 106 may see the target artifact 354. If the viewer 106 does see the target artifact 354, the viewer 106 can select the target artifact 354 to, for example, win a prize or enter a drawing, as described herein.

Various software components can be used to embed the advertising and the target artifact into the video. In one example, one or more of the following software products are used to embed the advertising and target artifact: Adobe® After Effects® CS4 and After Effects CS4 Mocha software from Adobe Systems Incorporated; Shake advanced digital compositing software from Apple Inc.; Boujou object tracking software from 2d3; 3D-Equalizer motion tracking software from Science.D.Visions; and Maya® 3D modeling, animation, visual effects, and rendering software and mental Ray® rendering engine software from Autodesk, Inc. Other tools can also be used.

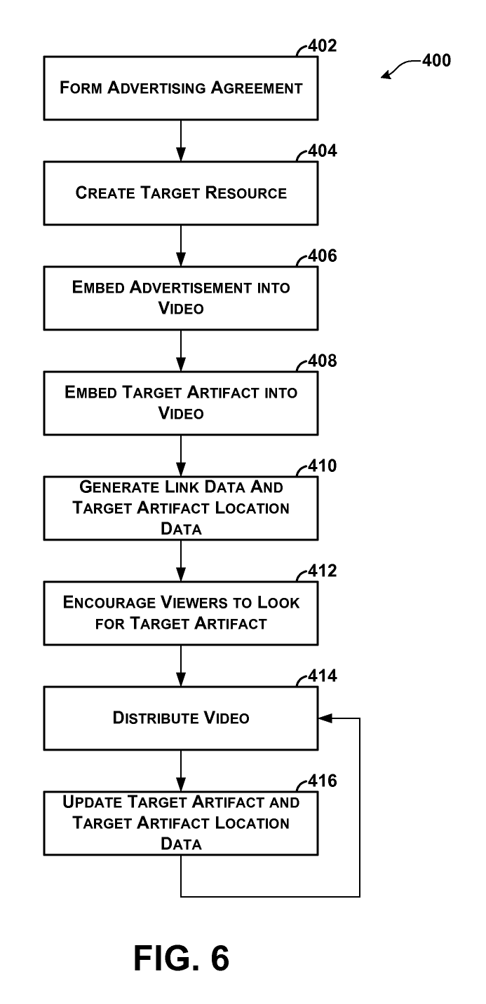

FIG. 6 illustrates an example operation 400 of an entity to distribute a video containing a target artifact designed to attract a viewer's attention to advertisements embedded in the video. It should be appreciated that the operation 400 is an example provided for purposes of explanation only. In other implementations, operations to distribute the video may involve more or fewer steps, or may involve the steps of the operation 400 in a different order. Furthermore, the operation 400 is explained with reference to FIGS. 1-3. It should be appreciated that other operations to distribute the video may be used in different systems and in computing systems having functional components other than those illustrated in the examples of FIGS. 1-3.

As illustrated in the example of FIG. 6, the operation 400 begins when the entity forms an advertising agreement with an advertiser (402). The advertising agreement obligates the entity to embed an advertisement and a target artifact in a video and to distribute the video.

Next, the entity creates a target resource (404). In different instances, the entity uses different tools to create the target resource. For example, the entity may use a web page design application to create the target resource. In another example, the entity may use an application programming suite to build software instructions that, when executed, provide the target resource. In some instances, a party other than the entity creates the target resource. For example, the advertiser may be responsible for creating the target resource.

Pursuant to the advertising agreement, the entity embeds one or more advertisements into the video (406). In different instances, the entity embeds the advertisements into the video in different ways. In a first example implementation, the entity manually identifies appropriate regions of frames in the video for the advertisements. In this first example, the entity may then use the video modification module 210 or other video manipulation software to manually update the identified regions to include the advertisements. In a second example implementation, the entity embeds the advertisements in the video by using a software application that automatically identifies appropriate regions of frames in the video for the advertisements. In this second example implementation, the software application may also automatically embed the advertisements in the identified regions.

It should be appreciated that, in some instances, the video may already contain the advertisements. In such instances, it may not be necessary for the entity to modify the video to contain the advertisements.

Next, the entity embeds a target artifact in the video (408). In different instances, the entity embeds the target artifact in the video in different ways. For instance, the entity may manually identify appropriate regions of frames and/or manually add the target artifact to the identified regions. In another instance, the entity may use a software application that automatically identifies appropriate regions of frames and/or automatically adds the target artifact to the identified regions. It should be appreciated that, in some instances, the video may already contain the target artifact. In such instances, it may not be necessary for the entity to modify the video to contain the target artifact.

The entity then generates link data and target artifact location data (410). The link data is data that indicates how to access target resource. The target artifact location data is data that indicates where the target artifact is located in the video. In an instance where the video is distributed in a video file, the video file may contain the link data and the target artifact location data. In an instance where the video is distributed in a video stream, the link data and the target artifact location data may be streamed to the playback device 104 as metadata in the video stream.

The entity then takes steps to encourage viewers to look for the target artifact in the video (412). As discussed above, the entity may take a wide variety of steps to encourage viewers to look for the target artifact in the video. For instance, the entity may include messages in the video encouraging viewers to look for the target artifact in the video.

Next, the entity distributes the video (414). As discussed above, the entity may distribute the video in a variety of ways. For instance, the entity may distribute the video by transmitting a video file or a video stream over an electronic communications network. In another instance, the entity may distribute the video by selling or giving away computer-readable storage media on which video data representing the video is stored.

Subsequently, the entity updates the target artifact in the video and the target artifact location data (416). For instance, the entity may change a location of the target artifact to a different location within a set of frames and/or to a different time within the video. In a second instance, the entity encourages viewers to look for a different artifact in the video. In this second instance, the entity updates the target artifact location data such that playback device 104 determines that the viewer 106 has selected the different target artifact. After updating the target artifact and the target artifact location data, the entity distributes the updated video (414). The entity may continue to update the target artifact and the target artifact location data on a regular or irregular basis. Once a viewer locates the target artifact, the viewer could potentially post the location of the target artifact in a public forum such as the Internet or print media. Consequently, the general public could quickly find the target artifact and access the target resource without paying attention to the details of the video. As a result, the viewers who already know the location of the target artifact are less likely to notice the advertisements embedded in the video. Updating the target artifact and the target artifact location data in this manner may diminish this possibility at least to some extent.

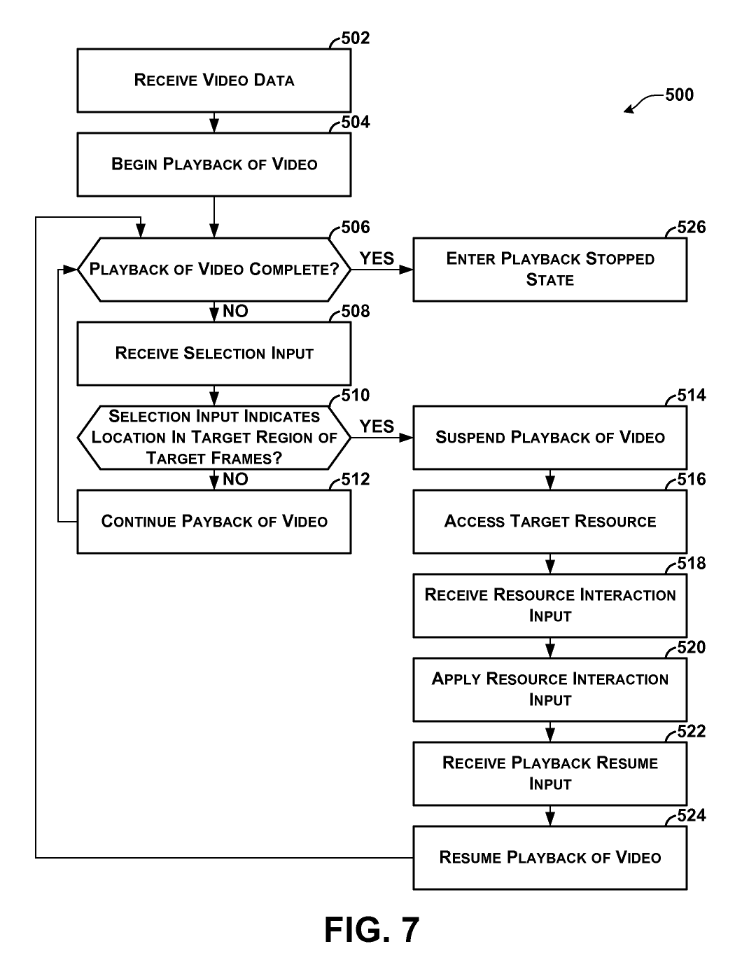

FIG. 7 illustrates an example operation 500 of the playback device 104 to play back the video. It should be appreciated that the operation 500 is an example provided for purposes of explanation only. In other implementations, operations to play back the video may involve more or fewer steps, or may involve the steps of the operation 500 in a different order. Furthermore, the operation 500 is explained with reference to FIGS. 1-3. It should be appreciated that other operations to play back the video may be used in different systems and in computing systems having functional components other than those illustrated in the examples of FIGS. 1-3.

As illustrated in the example of FIG. 7, the operation 500 begins when the playback application 310 receives video data (502). As discussed above, the playback application 310 may receive video data in a variety of ways. For instance, the playback application 310 may receive video data from a video file stored at the data storage system 300, a video stream received via the network interface 304, read from a computer-readable data storage medium via the storage device interface 306, generated by executing software instructions, and so on.

After receiving at least some of the video data, the playback application 310 begins playback of the video (504). After the playback application 310 begins playback of the video, the playback application 310 determines whether playback of the video is complete (506). Playback of the video is complete when the playback application 310 has displayed the last frame of the video.

If playback of the video is not complete (“NO” of 506), the playback application 310 is able to receive selection input from the viewer 106 (508). In other words, while the playback application 310 is playing back the video, the viewer 106 is able to provide selection input to the playback application 310.

In response to receiving the selection input, the playback application 310 determines whether the selection input indicates a location in a target region of a target frame (510). As used in this disclosure, a target frame is a frame containing a target artifact. Furthermore, as used in this disclosure, a target region in a frame is a region containing a target artifact. In some example implementations, the playback application 310 uses the target artifact location data to determine whether the selection input indicates a location in a target region of a target frame.

If the playback application 310 determines that the selection input does not indicate a location in a target region of a target frame of the video (“NO” of 510), the playback application 310 continues playback of the video (512). The playback application 310 then loops back and determines whether playback of the video is complete (506). If the playback application 310 never receives selection input or never receives selection input indicating a target region of a target frame of the video, the playback application 310 may continue to loop through steps 506, 508, 510, and 512 until playback of the video is complete.

On the other hand, if the playback application 310 determines that the selection input indicates a location in a target region of a target frame (“YES” of 510), the playback application 310 suspends playback of the video (514). Suspending playback of the video enables the viewer 106 to interact with the target resource and the resume viewing the video after the viewer 106 is finished interacting with the target resource.

Next, the playback application 310 accesses the target resource (516). In some example implementations, the playback application 310 uses link data to determine how to access the target resource. As described above, the playback application 310 may access the target resource in a wide variety of ways depending on the type of the target resource.

After accessing the target resource, the playback application 310 receives resource interaction input from the viewer 106 (518). The resource interaction input indicates things that the viewer 106 wants to do with the target resource. Because the target resource may be a wide variety of different types of resource, the resource interaction input may indicate a wide variety of things that the viewer 106 wants to do with the target resource. For example, if the target resource is a web page containing a web form, the resource interaction input may indicate data that the viewer 106 wants to enter into text boxes of the web form. In another example, if the target resource is a game, the resource interaction input may indicate actions that the viewer 106 wants to perform in the game.

In response to receiving the resource interaction input, the playback application 310 applies the resource interaction input to the target resource (520). Applying the resource interaction input to the target resource entails processing the resource interaction input in a manner appropriate for the target resource. Because the target resource may be a wide variety of different types of resource, the playback application 310 applies the resource interaction input in a wide variety of ways. For example, if the target resource is a web page containing a web form and the resource interaction input indicates data that the viewer 106 wants to enter into text boxes of the web form, the playback application 310 applies the resource interaction input by displaying the data in the text boxes. In another example, if the target resource is a game and the resource interaction input is a command to move a character in the game, the playback application 310 applies the resource interaction input by moving the character in the game.

Although not illustrated in the example of FIG. 7 for the sake of brevity, the playback application 310 may receive and apply many resource interaction inputs. Furthermore, it should be appreciate that there is no applicable resource interaction input for some target resources. For example, the target resource may simply be a message with a code that a user can enter in a web page to redeem a prize. In this example, the viewer 106 cannot provide resource interaction input to the message. In such instances, the operation 500 would not include steps 518 and 520.

Subsequently, the playback application 310 receives playback resume input from the viewer 106 (522). The playback resume input indicates to the playback application 310 that the viewer 106 wants to resume playback of the video. In response to receiving the playback resume input, the playback application 310 resumes playback of the video (524). The playback application 310 then loops back and determines whether playback of the video is complete (506). If playback of the video is complete (“YES” of 506), the playback application 310 enters a playback stopped state (526).

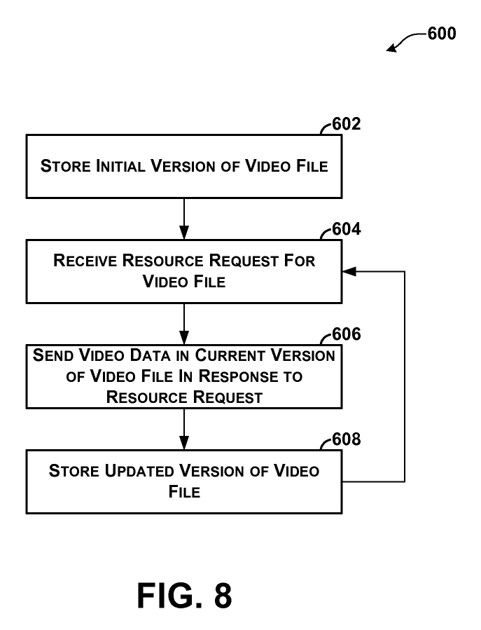

FIG. 8 illustrates an example operation 600 of the server computing system 102 to distribute the video. It should be appreciated that the operation 600 is an example provided for purposes of explanation only. In other implementations, operations to distribute the video may involve more or fewer steps, or may involve the steps of the operation 600 in a different order. Furthermore, the operation 600 is explained with reference to FIGS. 1-3. It should be appreciated that other operations to distribute the video may be used in different systems and in computing systems having functional components other than those illustrated in the examples of FIGS. 1-3.

As illustrated in the example of FIG. 8, the operation 600 starts when the server computing system 102 stores an initial version of the video file 206 (602). After the server computing system 102 has stored the initial version of the video file 206, the server application 208 receives a resource request for the video file (604). In response to receiving the resource request, the server application 208 transmits video data in the video file 206 to the playback device 104 (606).

Subsequently, the server computing system 102 stores an updated version of the video file 206 (608). The updated version of the video file 206 contains updated video data. The updated video data, when rendered by a playback device, plays back an updated video. The updated video is substantially the same as the initial version of the video, except that the updated video contains the target artifact at a location different than a location of the target artifact in the initial version of the video. In some instances, the updated version of the video file 206 is accompanied by different target artifact location data.

After storing the updated version of the video file 206, the server application 208 receives a second resource request (604). The second resource request may be from the playback device 104 or a different playback device. In response to the second resource request, the server application 208 transmits the updated video data in the updated version of the video file 206. Although not illustrated in the example of FIG. 8 for purposes of clarity, the server application 208 may receive and respond to many resource requests before storing the updated version of the video file 206.

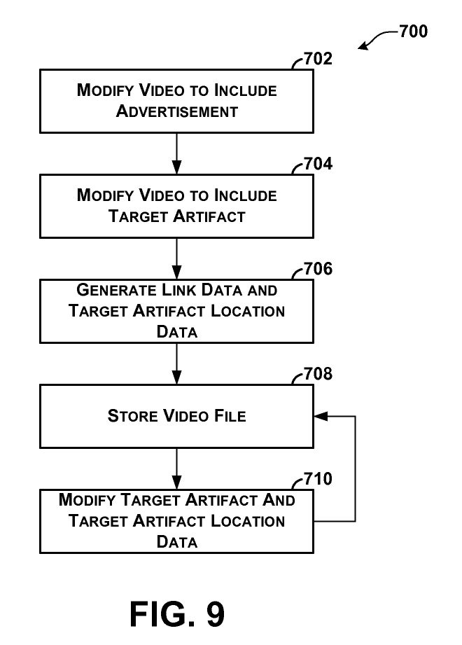

FIG. 9 illustrates an example operation 700 of the video modification module 210 to modify the video to contain the target artifact and the advertisements. It should be appreciated that the operation 700 is an example provided for purposes of explanation only. In other implementations, operations to modify the video may involve more or fewer steps, or may involve the steps of the operation 700 in a different order. Furthermore, the operation 700 is explained with reference to FIGS. 1-3. It should be appreciated that other operations to modify the video may be used in different systems and in computing systems having functional components other than those illustrated in the examples of FIGS. 1-3.

In the example of FIG. 9, the operation 700 starts when the video modification module 210 modifies the video file 206 such that the video includes at least one advertisement (702). The video modification module 210 may modify the video file 206 such that the video includes the advertisement in a variety of ways. In a first example implementation, the video modification module 210 automatically modifies the video file 206 such that the video includes the advertisement. In this first example implementation, a user provides the advertisement to the video modification module 210. The video modification module 210 then automatically identifies an appropriate location and time within the video to display the advertisement and automatically adds the advertisement at the identified location and time. In this first example implementation, the video modification module 210 may automatically perform various graphics operations on the advertisement to make the advertisement appear natural in the video. Such graphics operations include shadowing, bump mapping, perspective skewing, motion blurring, anti-aliasing, stretching, and so on. In other example implementations, a user may interact more closely with the video modification module 210 to modify the video file 206 such that the video includes the advertisement. For instance, the user may manually interact with the video modification module 210 to instruct the video modification module 210 where and when to place the advertisement in the video and/or what graphics operations to apply to the advertisement to make the advertisement appear natural in the video.

Next, the video modification module 210 modifies the video file 206 such that the video includes a target artifact (704). The video modification module 210 may modify the video file 206 such that the video includes the target artifact in a variety of ways. In a first example implementation, the video modification module 210 automatically modifies the video file 206 such that the video includes the target artifact. In this first example implementation, a user provides the target artifact to the video modification module 210. The video modification module 210 then automatically identifies an appropriate location and time within the video to display the target artifact and automatically adds the target artifact at the identified location and time. In this first example implementation, the video modification module 210 may automatically perform various graphics operations on the target artifact to make the target artifact appear natural in the video. In other example implementations, a user may interact more closely with the video modification module 210 to modify the video file 206 such that the video includes the target artifact. For instance, the user may manually interact with the video modification module 210 to instruct the video modification module 210 where and when to place the target artifact in the video and/or what graphics operations to apply to the target artifact to make the target artifact appear natural in the video.

After modifying the video to include the target artifact, the video modification module 210 generates link data and target artifact location data (706). The video modification module 210 may generate the link data and the target artifact location data in a variety of ways. For example, the video modification module 210 may cause a display device to display a user interface that enables a user to create the link data and/or the target artifact location data. In another example, the video modification module 210 generates the link data and/or the target artifact location data automatically.

Subsequently, the video modification module 210 stores the video file 206 at the data storage system 200 (708). After storing the video file 206 at the data storage system 200, the video modification module 210 modifies the video file 206 such that the target artifact is moved or such that the target artifact is replaced by another target artifact (710). As discussed above, moving or replacing the target artifact with another target artifact reduces the impact of distribution of knowledge regarding the location of the target artifact. In different implementations, the video modification module 210 modifies video file 206 such that the target artifact is moved or replace by another target artifact in different ways. For example, the video modification module 210 may automatically (i.e., without human intervention) modify the video file 206 such that the target artifact is moved or such that the target artifact is replaced by another target artifact. In another example, the video modification module 210 may modify the video file 206 such that the target artifact is moved or such that the target artifact is replaced by another target artifact in response to human interaction with the video modification module 210. After modifying the video file 206 such that the target artifact is moved or such that the target artifact is replaced by another target artifact, the video modification module 210 again stores the video file 206 (708). Steps 708 and 710 may recur an indefinite number of times.

In some examples, multiple runs or variations in the placement of the advertising and target artifacts can be made. For example, a first run of the movie can be made with a first set of advertisers, and a second run can be made with a different set of advertisers. The first run movie can be distributed for a certain number of viewers or for a certain amount of time, and then the second run movie can be used.

Likewise, multiple variations of the movie with different placement of the target artifacts can be used. In such an example, the multiple variations can each be distributed for a period of time, or all can be randomly distributed to viewers.

FIG. 10 illustrates example physical components of an electronic computing device 800. It should be appreciated that the electronic computing device 800 is merely one example. Other electronic computing devices may include more or fewer physical components and may be organized in different ways. The server computing system 102 may include one or more electronic computing devices like the electronic computing device 800. The playback device 104 may be implemented like the electronic computing device 800.

As illustrated in the example of FIG. 10, the electronic computing device 800 comprises a memory unit 802. The memory unit 802 is a computer-readable data storage medium capable of storing data and/or instructions. The memory unit 802 may be a variety of different types of computer-readable storage media including, but not limited to, dynamic random access memory (DRAM), double data rate synchronous dynamic random access memory (DDR SDRAM), solid state memory devices, reduced latency DRAM, DDR2 SDRAM, DDR3 SDRAM, Rambus RAM, or other types of computer-readable storage media.

In addition, the electronic computing device 800 comprises a processing unit 804. As mentioned above, a processing unit is a set of one or more physical electronic integrated circuits that are capable of executing instructions. In a first example, the processing unit 804 may execute software instructions that cause the electronic computing device 800 to provide specific functionality. In this first example, the processing unit 804 may be implemented as one or more processing cores and/or as a set of microprocessors, the set of microprocessors comprising at least one microprocessor. For instance, in this first example, the processing unit 804 may be implemented as one or more Intel Core 2 microprocessors. The processing unit 804 may be capable of executing instructions in an instruction set, such as the x86 instruction set, the POWER instruction set, a RISC instruction set, the SPARC instruction set, the IA-64 instruction set, the MIPS instruction set, or another instruction set. In a second example, the processing unit 804 may be implemented as an ASIC that provides specific functionality. In a third example, the processing unit 804 may provide specific functionality by using an ASIC and by executing software instructions.

The electronic computing device 800 also comprises a video interface 806. The video interface 806 enables the electronic computing device 800 to output video information to a display device 808. The display device 808 may be a variety of different types of display devices. For instance, the display device 808 may be a cathode-ray tube display, an LCD display panel, a plasma screen display panel, a touch-sensitive display panel, a LED array, an Organic LED (OLED) screen, or another type of display device.

In addition, the electronic computing device 800 includes a non-volatile storage device 810. The non-volatile storage device 810 is a computer-readable data storage medium that is capable of storing data and/or instructions. The non-volatile storage device 810 may be a variety of different types of non-volatile storage devices. For example, the non-volatile storage device 810 may be one or more hard disk drives, solid state memory devices, magnetic tape drives, CD-ROM drives, DVD-ROM drives, Blu-ray disc drives, or other types of non-volatile storage devices.

The electronic computing device 800 also includes an external component interface 812 that enables the electronic computing device 800 to communicate with external components. As illustrated in the example of FIG. 10, the external component interface 812 enables the electronic computing device 800 to communicate with an input device 814 and an external storage device 816. In one implementation of the electronic computing device 800, the external component interface 812 is a Universal Serial Bus (USB) interface. In another example implementation of the electronic computing device 800, the external component interface 812 is a FireWire interface. In other implementations of the electronic computing device 800, the electronic computing device 800 may include another type of interface that enables the electronic computing device 800 to communicate with input devices and/or output devices. For instance, the electronic computing device 800 may include a PS/2 interface. The input device 814 may be a variety of different types of devices including, but not limited to, keyboards, mice, trackballs, stylus input devices, touch pads, touch-sensitive display screens, or other types of input devices. The external storage device 816 may be a variety of different types of computer-readable data storage media including magnetic tape, flash memory modules, magnetic disk drives, optical disc drives, solid state memory devices, and other computer-readable data storage media.

In addition, the electronic computing device 800 includes a network interface card 818 that enables the electronic computing device 800 to transmit data to and receive data from an electronic communication network. The network interface card 818 may be a variety of different types of network interface. For example, the network interface card 818 may be an Ethernet interface, a token-ring network interface, a fiber optic network interface, a wireless network interface (e.g., a WiFi interface, a WiMax interface, Third Generation (3G) and Fourth Generation (4G) wireless communication interfaces, a Universal Mobile Telecommunications System interface, a CDMA2000 interface, an Evolution-Data Optimized interface, an Enhanced Data rates for GSM Evolution (EDGE) interface, etc.), or another type of network interface.

The electronic computing device 800 also includes a communications medium 820. The communications medium 820 facilitates communication among the various components of the electronic computing device 800. The communications medium 820 may comprise one or more different types of communications media including, but not limited to, a PCI bus, a PCI Express bus, an accelerated graphics port (AGP) bus, an Infiniband interconnect, a serial Advanced Technology Attachment (ATA) interconnect, a parallel ATA interconnect, a Fiber Channel interconnect, a USB bus, FireWire, Integrated Drive Electronics (IDE), elastic interface buses, a QuickRing bus, a Controller Area Network bus, a Scalable Coherent Interface bus, a USB bus, an Ethernet connection, a Small Computer System Interface (SCSI) interface, or another type of communications medium.

The electronic computing device 800 includes several computer-readable data storage media (i.e., the memory unit 802, the non-volatile storage device 810, and the external storage device 816). Together, these computer-readable storage media may constitute a single data storage system. As discussed above, a data storage system is a set of one or more computer-readable data storage mediums. This data storage system may store instructions executable by the processing unit 804. Activities described in the above description may result from the execution of the instructions stored on this data storage system. Thus, when this description says that a particular logical module performs a particular activity, such a statement may be interpreted to mean that instructions of the logical module, when executed by the processing unit 804, cause the electronic computing device 800 to perform the activity. In other words, when this description says that a particular logical module performs a particular activity, a reader may interpret such a statement to mean that the instructions configure the electronic computing device 800 such that the electronic computing device 800 performs the particular activity.

The techniques of this disclosure may be realized in a variety of ways. For example, the techniques of this disclosure may be realized as a method for attracting attention of a viewer to an advertisement embedded in a video. The method comprises playing back, by a playback device, the video to the viewer. The video comprises a sequence of frames. The sequence of frames comprises a first set of frames and a second set of frames. Each frame in the first set of frames comprises a different region in a first set of visually corresponding regions. Each frame in the second set of frames comprises a different region in a second set of visually corresponding regions. The first set of visually corresponding regions contains the advertisement. The advertisement is an artifact designed to raise awareness of a product offered by an entity. The second set of visually corresponding regions contains a target artifact. The target artifact is an artifact for which the viewer has been encouraged to look. The target artifact is at least somewhat difficult for the viewer to perceive except when the viewer is paying attention to details of the video. The method also comprises receiving, by the playback device, selection input from the viewer. The selection input indicates that the viewer has selected a location within a region in the second set of visually corresponding regions of the second set of frames. In addition, the method comprises in response to receiving the selection input, accessing, by the playback device, a target resource. The playback device does not access the target resource when the playback device does not receive the selection input.

In another example, the techniques of this disclosure may be realized as a playback device. The playback device comprising a data storage system that stores a playback application. The playback device also comprising a set of microprocessors that execute the playback application. The set of microprocessors includes at least one microprocessor. The playback application, when executed by the set of microprocessors, causes the playback device to play back a video to a viewer. The video comprises a sequence of frames. The sequence of frames comprises a first set of frames and a second set of frames. Each frame in the first set of frames comprises a different region in a first set of visually corresponding regions. Each frame in the second set of frames comprises a different region in a second set of visually corresponding regions. The first set of visually corresponding regions contains an advertisement. The advertisement is an artifact designed to raise awareness of a product offered by an entity. The second set of visually corresponding regions contains a target artifact. The target artifact is an artifact for which the viewer has been encouraged to look. The target artifact is at least somewhat difficult for the viewer to perceive except when the viewer is paying attention to details of the video. The software instructions, when executed by the set of microprocessors, further cause the playback device to receive selection input from the viewer. The selection input indicates that the viewer has selected a location within a region in the second set of visually corresponding regions of the second set of frames. In response to receiving the selection input, the software instructions, when executed by the set of microprocessors, further cause the playback device to access a target resource. The playback device does not access the target resource when the playback device does not receive the selection input.

In another example, the techniques of this disclosure may be realized as a computer-readable data storage medium comprising software instructions that, when executed by a playback device, cause the playback device to play back a video to a viewer. The video comprises a sequence of frames. The sequence of frames comprises a first set of frames and a second set of frames. Each frame in the first set of frames comprises a different region in a first set of visually corresponding regions. Each frame in the second set of frames comprises a different region in a second set of visually corresponding regions. The first set of visually corresponding regions contains an advertisement. The advertisement is an artifact designed to raise awareness of a product offered by an entity. The second set of visually corresponding regions contains a target artifact. The target artifact is an artifact for which the viewer has been encouraged to look. The target artifact is at least somewhat difficult for the viewer to perceive except when the viewer is paying attention to details of the video. The software instructions, when executed by the playback device, cause the playback device to receive, at the playback device, selection input from the viewer. The selection input indicates that the viewer has selected a location within a region in the second set of visually corresponding regions of the second set of frames. In response to receiving the selection input, the software instructions, when execute by the playback device, cause the playback device to access a target resource, the playback device not accessing the target resource when the playback device does not receive the selection input.

In another example, the techniques of this disclosure may be realized as a computing system comprising a data storage system. The data storage system stores software instructions and a video file comprising video data. The video data, when rendered by a playback device, causes the playback device to display a video. The video comprising a plurality of frames. The plurality of frames includes a first set of frames and a second set of frames. The first set of frames comprises a first set of visually corresponding regions. The second set of frames comprises a second set of visually corresponding regions. The first set of visually corresponding regions encompasses less than all viewable portions of the first set of frames. The second set of visually corresponding regions encompasses less than all viewable portions of the second set of frames. The first set of visually corresponding regions comprises an advertisement. The advertisement is an artifact designed to raise awareness of a product offered by an entity. The second set of visually corresponding regions comprises a target artifact. The target artifact is an artifact for which a viewer has been encouraged to look. The target artifact is at least somewhat difficult for the viewer to perceive except when the viewer is paying attention to details of the video. The target artifact, when selected by the viewer during playback of the video, causes the playback device to access a target resource. The computing system also comprises a processing unit comprising a set of microprocessors. The set of microprocessors comprises at least one microprocessor. The software instructions, when executed by the set of microprocessors, cause the computing system to transmit the video data to the playback device via an electronic communications network.

In another example, the techniques of this disclosure may be realized as a method for attracting attention of a viewer to an advertisement embedded in a video. The method comprises storing, at a data storage system, a video file comprising video data. The video data, when rendered by a playback device, causes the playback device to display the video. The video comprises a plurality of frames. The plurality of frames includes a first set of frames and a second set of frames. The first set of frames comprises a first set of visually corresponding regions. The second set of frames comprises a second set of visually corresponding regions. The first set of visually corresponding regions encompasses less than all viewable portions of the first set of frames. The second set of visually corresponding regions encompasses less than all viewable portions of the second set of frames. The first set of visually corresponding regions comprises the advertisement. The advertisement is an artifact designed to raise awareness of a product offered by an entity. The second set of visually corresponding regions comprises a target artifact. The target artifact is an artifact for which the viewer has been encouraged to look. The target artifact is at least somewhat difficult for the viewer to perceive except when the viewer is paying attention to details of the video. The target artifact, when selected by the viewer during playback of the video, causes the playback device to access a target resource. The method also comprises receiving, at a server computing system, a resource request from the playback device via an electronic communications network. The resource request requests the video. The method also comprises transmitting, by the server computing system, the video data to the playback device via the electronic communications network in response to the resource request.

In another example, the techniques of this disclosure may be realized as a computer-readable data storage medium that stores software instructions that, when executed by a computing device, cause the computing device to store, at a data storage system, a video file comprising video data. The video data, when rendered by a playback device, causes the playback device to display a video. The video comprises a plurality of frames. The plurality of frames includes a first set of frames and a second set of frames. The first set of frames comprises a first set of visually corresponding regions. The second set of frames comprises a second set of visually corresponding regions. The first set of visually corresponding regions encompasses less than all viewable portions of the first set of frames. The second set of visually corresponding regions encompasses less than all viewable portions of the second set of frames. The first set of visually corresponding regions comprises an advertisement. The advertisement is an artifact designed to raise awareness of a product offered by an entity. The second set of visually corresponding regions comprises a target artifact. The target artifact is an artifact for which a viewer has been encouraged to look. The target artifact is at least somewhat difficult for the viewer to perceive except when the viewer is paying attention to details of the video. The target artifact, when selected by the viewer during playback of the video, causes the playback device to access a target resource. The software instructions, when executed by the computing device, cause the computing device to receive, at a computing system, a resource request from the playback device via an electronic communications network. The resource request requests the video. In addition, the software instructions, when executed by the computing device, cause the computing device to transmit, by the computing system, the video data to the playback device via the electronic communications network in response to the resource request.

In another example, the techniques of this disclosure may be realized as a method for attracting attention of a viewer to an advertisement embedded in a video. The method comprises creating a target resource. In addition, the method comprises embedding an advertisement into the video, the advertisement being an artifact designed to raise awareness of a product offered by an entity. Furthermore, the method comprises embedding a target artifact into the video. The target artifact is an artifact for which a viewer is encouraged to look. The method also comprises generating link data. The link data indicating how a playback device is to access the target resource. Moreover, the method comprises generating target artifact location data. The target artifact location data indicates a location of the target artifact within the video. The method also comprises encouraging viewers to look for the target artifact. In addition, the method comprises distributing the video, link data, and target artifact location data. Furthermore, the method comprises updating a location within the video of the target artifact and the target artifact location data.

In another example, the techniques of this disclosure may be realized as computer-readable data storage medium that stores video data that, when rendered by a playback device, causes the playback device to present a video. The video comprises a sequence of frames. The sequence of frames comprises a first set of frames and a second set of frames. Each frame in the first set of frames comprises a different region in a first set of visually corresponding regions. Each frame in the second set of frames comprises a different region in a second set of visually corresponding regions. The first set of visually corresponding regions contains an advertisement. The advertisement is an artifact designed to raise awareness of a product offered by an entity. The second set of visually corresponding regions contains a target artifact. The target artifact is an artifact for which a viewer has been encouraged to look. The target artifact is at least somewhat difficult for the viewer to perceive except when the viewer is paying attention to details of the video. Moreover, the computer-readable data storage medium stores target artifact location data that indicates to the playback device where the target artifact is within the video. The computer-readable data storage medium also stores link data that indicates to the playback device how to access a target resource.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A method for attracting attention of a viewer to an advertisement embedded in a video, the method comprising:
playing back, by a playback device, the video to the viewer,
the video comprising a sequence of frames,
the sequence of frames comprising a first set of frames and a second set of frames,
each frame in the first set of frames comprising a different region in a first set of visually corresponding regions,
each frame in the second set of frames comprising a different region in a second set of visually corresponding regions,
the first set of visually corresponding regions containing the advertisement,
the advertisement being an artifact designed to raise awareness of a product offered by an entity,
the second set of visually corresponding regions containing a target artifact,
the target artifact being an artifact for which the viewer has been encouraged to look,
the target artifact being at least somewhat difficult for the viewer to perceive except when the viewer is paying attention to details of the video;
receiving, by the playback device, selection input from the viewer, the selection input indicating that the viewer has selected a location within a region in the second set of visually corresponding regions of the second set of frames; and
in response to receiving the selection input, accessing, by the playback device, a target resource, the playback device not accessing the target resource when the playback device does not receive the selection input.

2. The method of claim 1, wherein accessing the target resource comprises:
in response to receiving the selection input, transmitting, by the playback device, a resource request requesting the target resource via an electronic communications network; and
receiving, by the playback device, the target resource via the electronic communications network in response to the resource request.

3. The method of claim 2,
wherein the target resource is a web page; and
wherein accessing the target resource comprises displaying, by the playback device, the web page.

4. The method of claim 1,
wherein the target resource is a game; and
wherein accessing the target resource comprises executing, by the playback device, software instructions that cause the playback device to present the game.

5. The method of claim 1, wherein accessing the target resource comprises retrieving, by the playback device, the target resource from a data storage system at the playback device.

6. The method of claim 1,
wherein the method further comprises: prior to playing back the video, receiving video data at the playback device; and
wherein playing back the video comprises rendering the video data to produce the video.

7. The method of claim 6, wherein receiving the video data comprises: receiving, at the playback device, a video file containing the video data.

8. The method of claim 6, wherein receiving the video data comprises: receiving, at the playback device, a video stream containing the video data.

9. The method of claim 6, wherein receiving the video data comprises reading, by the playback device, the video data from an external data storage medium.

10. The method of claim 1,
wherein the method further comprises: prior to playing back the video, generating, at the playback device, video data by executing a video game application, the video game application being an application that, when executed, provides a video game; and
wherein playing back the video comprises rendering, by the playback device, the video data to produce the video.

11. The method of claim 1, wherein receiving the selection input comprises receiving, by the playback device, input indicating that the viewer has used an input device to select the location.

12. The method of claim 11, wherein the viewer has not been told where in the video to look for the target artifact.

13. The method of claim 12, wherein the viewer is encouraged to look for the target artifact with a chance to win a prize if the viewer finds the target artifact.

14. The method of claim 1, wherein the viewer has not been told where in the video to look for the target artifact.

15. The method of claim 1, wherein the viewer is encouraged to look for the target artifact with a chance to win a prize if the viewer finds the target artifact.

16. A method for attracting attention of a viewer to an advertisement embedded in a video, the method comprising:
storing, at a data storage system, a video file comprising video data,
the video data, when rendered by a playback device, causes the playback device to display the video,
the video comprising a plurality of frames,
the plurality of frames including a first set of frames and a second set of frames,
the first set of frames comprising a first set of visually corresponding regions,
the second set of frames comprising a second set of visually corresponding regions,
the first set of visually corresponding regions encompassing less than all viewable portions of the first set of frames,
the second set of visually corresponding regions encompassing less than all viewable portions of the second set of frames,
the first set of visually corresponding regions comprising the advertisement,
the advertisement being an artifact designed to raise awareness of a product offered by an entity,
the second set of visually corresponding regions comprising a target artifact,
the target artifact being an artifact for which the viewer has been encouraged to look,
the target artifact being at least somewhat difficult for the viewer to perceive except when the viewer is paying attention to details of the video,
the target artifact, when selected by the viewer during playback of the video, causes the playback device to access a target resource; and
receiving, at a server computing system, a resource request from the playback device via an electronic communications network, the resource request requesting the video; and
transmitting, by the server computing system, the video data to the playback device via the electronic communications network in response to the resource request.

17. The method of claim 16, further comprising:
storing, by the server computing system, an updated version of the video file, the updated version of the video file comprising updated video data, the updated video data, when rendered by the playback device, plays back an updated video, the updated video being substantially the same as the video, except the updated video containing the target artifact at a location different than a location of the target artifact in the video; and
transmitting, by the server computing system, the updated video data to a second playback device.

18. A method for attracting attention of a viewer to an advertisement embedded in a video, the method comprising:
creating a target resource;
embedding an advertisement into the video, the advertisement being an artifact designed to raise awareness of a product offered by an entity;
embedding a target artifact into the video, the target artifact being an artifact for which a viewer is encouraged to look;
generating link data, the link data indicating how a playback device is to access the target resource;
generating target artifact location data, the target artifact location data indicates a location of the target artifact within the video;
encouraging viewers to look for the target artifact;
distributing the video, link data, and target artifact location data; and
updating a location within the video of the target artifact and the target artifact location data.

19. The method of claim 18, further comprising storing, by a server computing system, an updated version of the video, the updated version of the video comprising updated video data, the updated video data, when rendered by the playback device, plays back an updated video, the updated video being substantially the same as the video, except the updated video containing the target artifact at a location different than a location of the target artifact in the video.

20. The method of claim 19, further comprising transmitting, by the server computing system, the updated video data to a second playback device.
